(19) United States
(12) Patent Application Publication
(10) Pub. No.: US 2026/0017529 A1
(43) Pub. Date: Jan. 15, 2026

(54) APPARATUS AND METHOD FOR REPRODUCING TABULAR DATA

(71) Applicant: ELECTRONICS AND TELECOMMUNICATIONS RESEARCH INSTITUTE, Daejeon (KR)

(72) Inventors: Sung Yup LEE, Daejeon (KR); Cheol Ho KIM, Daejeon (KR); Byoung Hwa LEE, Daejeon (KR); Jung Hoon LEE, Daejeon (KR)

(73) Assignee: ELECTRONICS AND TELECOMMUNICATIONS RESEARCH INSTITUTE, Daejeon (KR)

(21) Appl. No.: 18/918,943

(22) Filed: Oct. 17, 2024

(30) Foreign Application Priority Data
Jul. 11, 2024 (KR) 10-2024-0091725

(51) Int. Cl. G06N 3/092

(52) U.S. Cl. CPC G06N 3/092

(57) ABSTRACT

The present invention relates to an apparatus for reproducing tabular data. The apparatus for reproducing tabular data includes a generative flow networks (GFlowNets) learning network, a critic network, and a processor that performs learning through the GFlowNets learning network and the critic network, in which the processor performs learning of a policy network of GFlowNets and learning using real data, and performs learning of the critic network based on the real data and data generated by the GFlowNets.

### CROSS-REFERENCE TO RELATED APPLICATION

This application claims priority to and the benefit of Korean Patent Application No. 10-2024-0091725, filed on Jul. 11, 2024, the disclosure of which is incorporated herein by reference in its entirety.

### BACKGROUND

### 1. Field of the Invention

The present invention relates to an apparatus and method for reproducing tabular data, which are capable of reproducing tabular data with a traceable generation process.

### 2. Discussion of Related Art

Tabular data is a type of table data and is provided as data for machine learning and also refers to data for preprocessing and visualization processing that is a target of an artificial intelligence (AI) model.

In general, such tabular data is mainly handled in high value-added industries such as healthcare and finance. The tabular data used in these fields is often generated and refined by people, which incurs significant costs in the generation, collection, and sharing of the data. Therefore, attempts to synthesize and augment the tabular data have been continuously made.

The existing widely known tabular data generation techniques include modeling tabular data using conditional GAN (CTGAN) and modeling tabular data with diffusion models (TabDDPM). However, these techniques may actively utilize deep neural networks to generate good quality data, but have the disadvantage of being unable to analyze or interpret the generation process.

Accordingly, an apparatus and method for reproducing tabular data, which are capable of generating good-quality tabular data and reproducing tabular data with a traceable generation process, are needed.

The background art of the present invention is disclosed in Korean Patent No. 10-2342580 (Dec. 20, 2021).

### SUMMARY OF THE INVENTION

The present invention provides an apparatus and method for reproducing tabular data, which are capable of reproducing tabular data with a traceable generation process.

According to an aspect of the present invention, there is provided an apparatus for reproducing tabular data, including a generative flow networks (GFlowNets) learning network; a critic network; and a processor that performs learning through the GFlowNets learning network and the critic network, in which the processor performs learning of a policy network of GFlowNets and learning using real data, and performs learning of the critic network based on the real data and data generated by the GFlowNets.

Prior to the learning of the policy network of the GFlowNets, the processor may preprocess a continuous variable as a training data preprocessing process, and convert the preprocessed continuous variable into a categorical variable and a one-hot vector.

The processor may sample a predefined variable value (c) from a Bernoulli distribution with a specified probability in a process of learning the policy network of the GFlowNets.

The predefined variable value (c) may be a value for selecting a routine for the GFlowNets to perform learning using the real data or a routine for learning the data generated by the GFlowNets.

When the predefined variable value (c) is a specified first specific value, the processor may sample a trajectory from an end state to a start state using a reverse policy of the GFlowNets.

When the predefined variable value (c) is a specified second specific value, the processor may sample a trajectory from a start state to an end state using a forward policy of the GFlowNets.

In the process of learning the policy network of the GFlowNets, the processor may update all parameters of the GFlowNets using trajectory balance loss.

In the process of performing the learning of the critic network, the processor may sample a new end state using a forward policy of the GFlowNets.

In the process of performing the learning of the critic network, the processor may update a parameter corresponding to a reward of the critic network using an objective function of Wasserstein GAN with gradient penalty (WGAN-GP) based on training data converted into a one-hot vector and the sampled new end state.

The critic may be a value indicating how close data given as an input is to the actual data, and the closer the data generated by the GFlowNets may be to the actual data, the greater the reward, and the farther the generated data may be from the actual data, the smaller the reward.

According to another aspect of the present invention, there is provided a method of reproducing tabular data that causes a processor to perform the processes of learning a policy network of generative flow networks (GFlowNets); performing GFlowNets learning based on real data; performing exploration and learning through the policy network learned by the GFlowNets; and learning a critic network.

The method may further include, prior to the process of learning the policy network of the GFlowNets, as a training data preprocessing process, a process of preprocessing a continuous variable and converting the preprocessed continuous variable into a categorical variable and a one-hot vector.

In the process of learning the policy network of the GFlowNets, a predefined variable value (c) may be sampled from a Bernoulli distribution with a specified probability.

The predefined variable value (c) may be a value for selecting a routine for the GFlowNets to perform learning using the real data or a routine for learning the data generated by the GFlowNets.

When the predefined variable value (c) is a specified first specific value, a trajectory from an end state to a start state may be sampled using a reverse policy of the GFlowNets.

When the predefined variable value (c) is a specified second specific value, a trajectory from a start state to an end state may be sampled using a forward policy of the GFlowNets.

In the process of learning the policy network of the GFlowNets, all parameters of GFlowNets may be updated using trajectory balance loss.

The process of performing the learning of the critic network may include sampling a new end state using a forward policy of the GFlowNets.

In the process of performing the learning of the critic network, a parameter corresponding to a reward of the critic network may be updated using an objective function of Wasserstein GAN with gradient penalty (WGAN-GP) based on training data converted into a one-hot vector and the sampled new end state.

The critic may be a value indicating how close data given as an input is to the actual data, and the closer the data generated by the GFlowNets may be to the actual data, the greater the reward, and the farther the generated data may be from the actual data, the smaller the reward.

### BRIEF DESCRIPTION OF THE DRAWINGS

FIG. 1 is an exemplary diagram for describing a process of generating tabular data defined as a directed acyclic graph (DAG) according to an embodiment of the present invention.

FIG. 2 is an exemplary diagram for describing the definitions of states and state transitions of variables according to the present embodiment in FIG. 1.

FIG. 3 is an exemplary diagram for describing a process of generating variables during the process of generating tabular data in FIG. 1.

FIG. 4 is an exemplary diagram for describing a joint learning technique for simultaneously performing learning of generative flow network (GFlowNets) and learning of a critic network of Wasserstein GAN with gradient penalty (WGAN-GP) according to an embodiment of the present invention.

### DETAILED DESCRIPTION OF EXEMPLARY EMBODIMENTS

The components described in the example embodiments may be implemented by hardware components including, for example, at least one digital signal processor (DSP), a processor, a controller, an application-specific integrated circuit (ASIC), a programmable logic element, such as an FPGA, other electronic devices, or combinations thereof. At least some of the functions or the processes described in the example embodiments may be implemented by software, and the software may be recorded on a recording medium. The components, the functions, and the processes described in the example embodiments may be implemented by a combination of hardware and software.

The method according to example embodiments may be embodied as a program that is executable by a computer, and may be implemented as various recording media such as a magnetic storage medium, an optical reading medium, and a digital storage medium.

Various techniques described herein may be implemented as digital electronic circuitry, or as computer hardware, firmware, software, or combinations thereof. The techniques may be implemented as a computer program product, i.e., a computer program tangibly embodied in an information carrier, e.g., in a machine-readable storage device (for example, a computer-readable medium) or in a propagated signal for processing by, or to control an operation of a data processing apparatus, e.g., a programmable processor, a computer, or multiple computers. A computer program(s) may be written in any form of a programming language, including compiled or interpreted languages and may be deployed in any form including a stand-alone program or a module, a component, a subroutine, or other units suitable for use in a computing environment. A computer program may be deployed to be executed on one computer or on multiple computers at one site or distributed across multiple sites and interconnected by a communication network.

Processors suitable for execution of a computer program include, by way of example, both general and special purpose microprocessors, and any one or more processors of any kind of digital computer. Generally, a processor will receive instructions and data from a read-only memory or a random access memory or both. Elements of a computer may include at least one processor to execute instructions and one or more memory devices to store instructions and data. Generally, a computer will also include or be coupled to receive data from, transfer data to, or perform both on one or more mass storage devices to store data, e.g., magnetic, magneto-optical disks, or optical disks. Examples of information carriers suitable for embodying computer program instructions and data include semiconductor memory devices, for example, magnetic media such as a hard disk, a floppy disk, and a magnetic tape, optical media such as a compact disk read only memory (CD-ROM), a digital video disk (DVD), etc. and magneto-optical media such as a floptical disk, and a read only memory (ROM), a random access memory (RAM), a flash memory, an erasable programmable ROM (EPROM), and an electrically erasable programmable ROM (EEPROM) and any other known computer readable medium. A processor and a memory may be supplemented by, or integrated into, a special purpose logic circuit.

The processor may run an operating system (OS) and one or more software applications that run on the OS. The processor device also may access, store, manipulate, process, and create data in response to execution of the software. For purpose of simplicity, the description of a processor device is used as singular; however, one skilled in the art will be appreciated that a processor device may include multiple processing elements and/or multiple types of processing elements. For example, a processor device may include multiple processors or a processor and a controller. In addition, different processing configurations are possible, such as parallel processors.

Also, non-transitory computer-readable media may be any available media that may be accessed by a computer, and may include both computer storage media and transmission media.

The present specification includes details of a number of specific implements, but it should be understood that the details do not limit any invention or what is claimable in the specification but rather describe features of the specific example embodiment. Features described in the specification in the context of individual example embodiments may be implemented as a combination in a single example embodiment. In contrast, various features described in the specification in the context of a single example embodiment may be implemented in multiple example embodiments individually or in an appropriate sub-combination. Furthermore, the features may operate in a specific combination and may be initially described as claimed in the combination, but one or more features may be excluded from the claimed combination in some cases, and the claimed combination may be changed into a sub-combination or a modification of a sub-combination.

Similarly, even though operations are described in a specific order on the drawings, it should not be understood as the operations needing to be performed in the specific order or in sequence to obtain desired results or as all the operations needing to be performed. In a specific case, multitasking and parallel processing may be advantageous. In addition, it should not be understood as requiring a separation of various apparatus components in the above described example embodiments in all example embodiments, and it should be understood that the above-described program components and apparatuses may be incorporated into a single software product or may be packaged in multiple software products.

It should be understood that the example embodiments disclosed herein are merely illustrative and are not intended to limit the scope of the invention. It will be apparent to one of ordinary skill in the art that various modifications of the example embodiments may be made without departing from the spirit and scope of the claims and their equivalents.

Hereinafter, with reference to the accompanying drawings, embodiments of the present disclosure will be described in detail so that a person skilled in the art can readily carry out the present disclosure. However, the present disclosure may be embodied in many different forms and is not limited to the embodiments described herein.

In the following description of the embodiments of the present disclosure, a detailed description of known functions and configurations incorporated herein will be omitted when it may make the subject matter of the present disclosure rather unclear. Parts not related to the description of the present disclosure in the drawings are omitted, and like parts are denoted by similar reference numerals.

In the present disclosure, components that are distinguished from each other are intended to clearly illustrate each feature. However, it does not necessarily mean that the components are separate. That is, a plurality of components may be integrated into one hardware or software unit, or a single component may be distributed into a plurality of hardware or software units. Thus, unless otherwise noted, such integrated or distributed embodiments are also included within the scope of the present disclosure.

In the present disclosure, components described in the various embodiments are not necessarily essential components, and some may be optional components. Accordingly, embodiments consisting of a subset of the components described in one embodiment are also included within the scope of the present disclosure. In addition, embodiments that include other components in addition to the components described in the various embodiments are also included in the scope of the present disclosure.

Hereinafter, with reference to the accompanying drawings, embodiments of the present disclosure will be described in detail so that a person skilled in the art can readily carry out the present disclosure. However, the present disclosure may be embodied in many different forms and is not limited to the embodiments described herein.

In the following description of the embodiments of the present disclosure, a detailed description of known functions and configurations incorporated herein will be omitted when it may make the subject matter of the present disclosure rather unclear. Parts not related to the description of the present disclosure in the drawings are omitted, and like parts are denoted by similar reference numerals.

In the present disclosure, when a component is referred to as being “linked,” “coupled,” or “connected” to another component, it is understood that not only a direct connection relationship but also an indirect connection relationship through an intermediate component may also be included. In addition, when a component is referred to as “comprising” or “having” another component, it may mean further inclusion of another component not the exclusion thereof, unless explicitly described to the contrary.

In the present disclosure, the terms first, second, etc. are used only for the purpose of distinguishing one component from another, and do not limit the order or importance of components, etc., unless specifically stated otherwise. Thus, within the scope of this disclosure, a first component in one exemplary embodiment may be referred to as a second component in another embodiment, and similarly a second component in one exemplary embodiment may be referred to as a first component.

In the present disclosure, components that are distinguished from each other are intended to clearly illustrate each feature. However, it does not necessarily mean that the components are separate. That is, a plurality of components may be integrated into one hardware or software unit, or a single component may be distributed into a plurality of hardware or software units. Thus, unless otherwise noted, such integrated or distributed embodiments are also included within the scope of the present disclosure.

In the present disclosure, components described in the various embodiments are not necessarily essential components, and some may be optional components. Accordingly, embodiments consisting of a subset of the components described in one embodiment are also included within the scope of the present disclosure. In addition, exemplary embodiments that include other components in addition to the components described in the various embodiments are also included in the scope of the present disclosure.

Hereinafter, an apparatus and method for reproducing tabular data will be described according to embodiments of the present invention.

In the embodiments according to the present invention, when considering variables of tabular data as probability variables, a joint distribution between variables may be resolved as a connection of conditional probability distributions as in the following equation.

$$P ( X , Y , Z ) = P ( X ) P ( Y \vert X ) P ( Z \vert X , Y )$$

Generative flow networks (GFlowNets) may resolve state transitions as conditional probability distributions, and express a process of a series of state transitions expressed as trajectories as a chain of the conditional probability distributions. According to the chain rule, this chain may be viewed as a joint probability, and the joint probability is proportional to the given reward.

When the states and state transitions of GFlowNets are defined as a process of generating variables of tabular data, and an appropriate reward may be provided as a value function proportional to the joint distribution, a probability model that follows the joint distribution of the given data may be generated using GFlowNets, and good-quality tabular data may be generated using the probability model.

The present invention relates to a method of generating tabular data that may generate good-quality tabular data using GFlowNets, whose generation process is described by the conditional probability distribution, and trace the process.

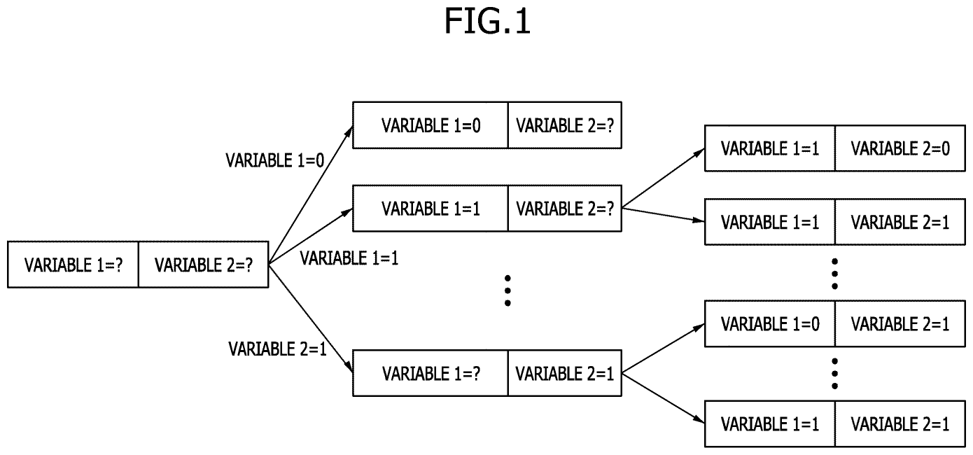

FIG. 1 is an exemplary diagram for describing a process of generating tabular data defined as a directed acyclic graph (DAG) according to an embodiment of the present invention.

Here, the DAG means a directed non-cyclic graph.

The tabular data illustrated in FIG. 1 is composed of variables 1 and 2.

The leftmost state corresponding to a root node is a start state where no value is set. “?” means that a value is not set yet.

In addition, it can be seen through an edge from a start state that state transitions occur when it is determined that a value of variable 1 is 0, when it is determined that a value of variable 1 is 1, when it is determined that a value of variable 2 is 0, when it is determined that a value of variable 2 is 1, etc.

In this way, a process of generating variables of tabular data may be defined in the form of the DAG.

Since the edge of GFlowNets may handle only a discrete probability distribution, continuous variables of tabular data (i.e., variables that may be composed of numbers, compared in size, and have another value between values) should be converted into categorical variables (categorical variables: variables that may have a limited number of values, may be divided according to criteria, may not belong to multiple places at the same time, and may not belong to places other than criteria) through the preprocessing process.

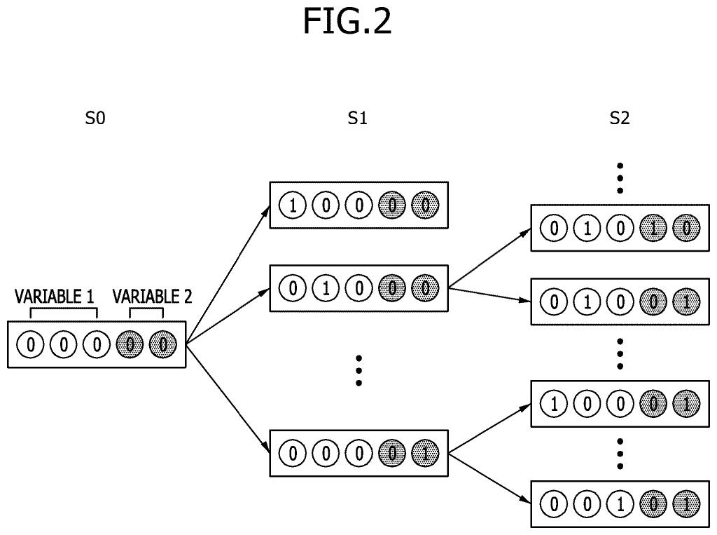

FIG. 2 is an exemplary diagram for describing the definitions of the states and state transitions of the variables according to the present embodiment in FIG. 1, and describes the states and state transitions of the variables for using GFlowNets while following the expression of the process of generating tabular data described in FIG. 1.

Referring to FIG. 2, each variable of the tabular data according to the present embodiment is expressed in the form of a one-hot vector, and when it is determined that there is nothing, all values of the vector are indicated as 0.

The drawing illustrated in FIG. 2 is illustrated according to the definitions of the states and state transitions of the variables by taking the example of FIG. 1 without change.

The left state, which means a start state S0, has no value determined, so all values of the one-hot vector are filled with 0, and a top state S1 in the center, where it is determined that a value of variable 1 is 0, can be expressed as a concatenation of vectors of variable 1 expressed as a one-hot vector and variable 2 filled with 0.

Through the definitions of these states and state transitions of the variables, all the states may indicate which values of the variables are generated and, if so, what that values are.

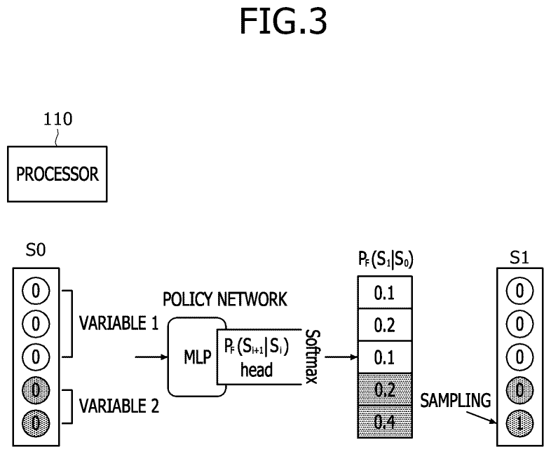

FIG. 3 is an exemplary diagram for describing the process of generating variables among the process of generating tabular data in FIG. 1, and exemplarily illustrates the process of determining the value of variable 2 to be 1.

In this case, the policy network of GFlowNets includes the following four components.
(1) Learnable scalar parameters for learning an overall flow z of the DAG
(2) Multi layer perceptron structure (MLP) that forms a body of a policy network
(3) Output layer (P_{F} head) for output of a forward policy
(4) Output layer (P_{B} head) for output of a reverse policy

In this case, in the process of generating tabular data, the process of generating variables is a process of generating next variables through the output P_{F} of the GFlowNets policy network in the start state.

As illustrated in FIG. 3, when the current state is input to the GFlowNets policy network, the conditional probability distribution (e.g., 0.1, 0.2, 0.1, 0.2, and 0.4) for the following variables is output as the output.

Since it passes through the deep network, a softmax function (i.e., a function that generalizes a logistic function to multiple dimensions) should be applied to a final stage of the output layer to be transformed into a probability. In this case, random sampling is performed based on the output conditional probability distribution to determine the next variables. For example, in the case of FIG. 3, the process of determining the value of variable 2 as 1 is illustrated.

In order to sample the trajectory to be used for learning, reverse sampling may be performed using the reverse output head P_{B} of the policy network from the given data. This process may be compared to a process of deleting variables one by one from the data in reverse.

This generation process is repeated until all the variables are generated or removed, and in each process, the probability distribution is output as P_{F}(s₁|s₀) in FIG. 3, which may be used to identify the correlation between variables.

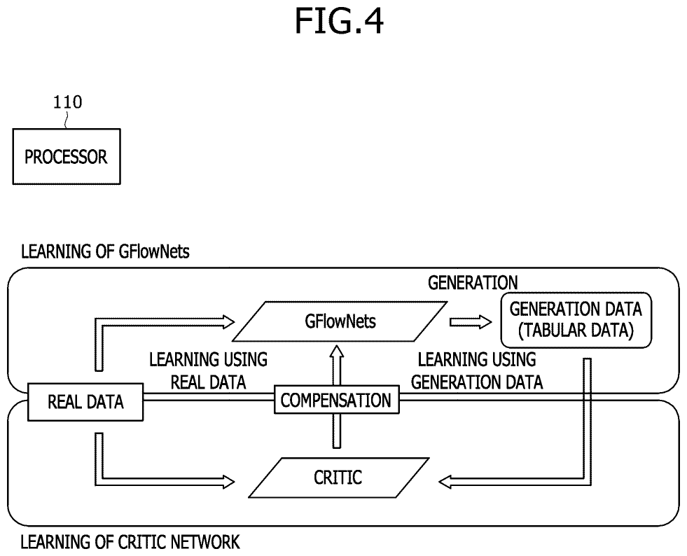

In addition, the present invention provides a method of using a critic network of Wasserstein GAN with gradient penalty (WGAN-GP) as a reward function for GFlowNets learning (see FIG. 4).

Although it is theoretically best to apply a likelihood function of real data as the reward function, it is generally known to be very difficult to directly model a data distribution of multiple variables and find the likelihood function.

Therefore, the present invention provides a method of using a critic network of WGAN-GP, which outputs a quality score in consideration of the distribution of real data and generated data, as a reward function R (x).

Here, the critic network is formed with an MLP structure and is configured to output a single scalar value as an output.

FIG. 4 is an exemplary diagram for describing a joint learning technique for simultaneously performing the learning of GFlowNets and the learning of the critic network of WGAN-GP according to an embodiment of the present invention.

Referring to FIG. 4, the joint learning process is as follows.

(1) Training data preprocessing: Continuous variables (i.e., variables that may be composed of numbers, compared in size, and have another value between values) are preprocessed to be converted into categorical variables (i.e., variables that may be divided according to criteria, may not belong to multiple places at the same time, and may not belong to places other than criteria) and into one-hot vectors (see FIG. 2).

(2) c˜Bernoulli (0.5): Sample a variable value (e.g., a variable value for selecting a left routine (i.e., a routine for performing learning using real data) or a right routine (i.e., a routine for learning generated data)) called c (predefined probability) from a Bernoulli distribution with a specified probability (e.g., 0.5).

(3) When c is a first specific value (e.g., 0), sample a trajectory (e.g., referring to FIG. 2, a state transition process in which data is output from the rightmost state S1 to the leftmost state S0) using the reverse policy of GFlowNets.

(4) When c is a second specific value (e.g., 1), sample a trajectory from the start state S0 to the end state S2 using the forward policy of GFlowNets.

(5) Update the all parameters of GFlowNets using trajectory balance loss.

(6) Using the forward policy of GFlowNets (see FIG. 3), sample a new end state (data of the rightmost state (S2) in FIG. 2 is generated).

(7) Update the parameters of the critic (value indicating how close the input data is to the real data) network (corresponding to the reward in FIG. 4, e.g., the closer to the real data, the greater the reward, and the farther from the real data, the smaller the reward) by using the objective function of WGAN-GP with the training data converted into one-hot vectors and the end state sampled in (6).

(8) Return to (2) and repeat until the convergence condition is satisfied.

Processes (2) to (5) are the processes of learning the policy network of GFlowNets.

Process (3) is the process of performing learning based on the real data, and process (4) may be viewed as the process of performing exploration and learning through the policy network currently learned by GFlowNets.

Processes (6) to (7) are the processes of learning the critic network.

The critic network learns the real data and the generated data in the context of contrastive learning, and the policy network of GFlowNets can be considered to quickly learn the state space through the real data and explore and learn the surrounding state space of the trajectory of the real data through the forward policy.

As illustrated in FIG. 3, the conditional probability distribution that appears in the process of generating variables is transparently revealed.

This may be utilized to identify the relationship between variables.

On the other hand, other existing methods (e.g., modeling tabular data using conditional GAN (CTGAN), modeling tabular data with diffusion models (TabDDPM)) may not trace the generation process on their own.

In this way, the present embodiment may support the generation of good-quality tabular data, the estimation and analysis of the process of generating tabular data, and the reproduction of tabular data with a traceable generation process.

According to one aspect of the present invention, it is possible to support the generation of good-quality tabular data.

In addition, according to the present invention, it is possible to support the estimation and analysis of the process of generating tabular data.

In addition, according to the present invention, it is possible to support the reproduction of tabular data with a traceable generation process.

What is claimed is:

1. An apparatus for reproducing tabular data, comprising:
a generative flow networks (GFlowNets) learning network;
a critic network; and
a processor that performs learning through the GFlowNets learning network and the critic network,
wherein the processor performs learning of a policy network of GFlowNets and learning using real data, and performs learning of the critic network based on the real data and data generated by the GFlowNets.

2. The apparatus of claim 1, wherein, prior to the learning of the policy network of the GFlowNets, the processor preprocesses a continuous variable as a training data preprocessing process, and converts the preprocessed continuous variable into a categorical variable and a one-hot vector.

3. The apparatus of claim 1, wherein the processor samples a predefined variable value (c) from a Bernoulli distribution with a specified probability in a process of learning the policy network of the GFlowNets.

4. The apparatus of claim 3, wherein the predefined variable value (c) is a value for selecting a routine for the GFlowNets to perform learning using the real data or a routine for learning the data generated by the GFlowNets.

5. The apparatus of claim 3, wherein, when the predefined variable value (c) is a specified first specific value, the processor samples a trajectory from an end state to a start state using a reverse policy of the GFlowNets.

6. The apparatus of claim 3, wherein, when the predefined variable value (c) is a specified second specific value, the processor samples a trajectory from a start state to an end state using a forward policy of the GFlowNets.

7. The apparatus of claim 3, wherein, in the process of learning the policy network of the GFlowNets, the processor updates all parameters of the GFlowNets using a trajectory balance loss.

8. The apparatus of claim 1, wherein, in the process of performing the learning of the critic network, the processor samples a new end state using a forward policy of the GFlowNets.

9. The apparatus of claim 8, wherein, in the process of performing the learning of the critic network, the processor updates a parameter corresponding to a reward of the critic network using an objective function of Wasserstein GAN with gradient penalty (WGAN-GP) based on training data converted into a one-hot vector and the sampled new end state.

10. The apparatus of claim 9, wherein the critic is a value indicating how close data given as an input is to the actual data, and the closer the data generated by the GFlowNets is to the actual data, the greater the reward, and the farther the generated data is from the actual data, the smaller the reward.

11. A method of reproducing tabular data that causes a processor to perform the processes of:
learning a policy network of generative flow networks (GFlowNets);
performing GFlowNets learning based on real data;
performing exploration and learning through the policy network learned by the GFlowNets; and
learning a critic network.

12. The method of claim 11, further comprising, prior to the process of learning the policy network of the GFlowNets, as a training data preprocessing process, a process of preprocessing a continuous variable and converting the preprocessed continuous variable into a categorical variable and a one-hot vector.

13. The method of claim 11, wherein, in the process of learning the policy network of the GFlowNets, a predefined variable value (c) is sampled from a Bernoulli distribution with a specified probability.

14. The method of claim 13, wherein the predefined variable value (c) is a value for selecting a routine for the GFlowNets to perform learning using the real data or a routine for learning the data generated by the GFlowNets.

15. The method of claim 13, wherein, when the predefined variable value (c) is a specified first specific value, a trajectory from an end state to a start state is sampled using a reverse policy of the GFlowNets.

16. The method of claim 13, wherein, when the predefined variable value (c) is a specified second specific value, a trajectory from a start state to an end state is sampled using a forward policy of the GFlowNets.

17. The method of claim 13, wherein, in the process of learning the policy network of the GFlowNets, all parameters of the GFlowNets are updated using trajectory balance loss.

18. The method of claim 11, wherein the process of performing the learning of the critic network includes sampling a new end state using a forward policy of the GFlowNets.

19. The method of claim 18, wherein, in the process of performing the learning of the critic network, a parameter corresponding to a reward of the critic network is updated using an objective function of Wasserstein GAN with gradient penalty (WGAN-GP) based on training data converted into a one-hot vector and the sampled new end state.

20. The method of claim 19, wherein the critic is a value indicating how close data given as an input is to the actual data, and the closer the data generated by the GFlowNets is to the actual data, the greater the reward, and the farther the generated data is from the actual data, the smaller the reward.
